(19) United States
(12) Patent Application Publication
(10) Pub. No.: US 2004/0112339 A1
(43) Pub. Date: Jun. 17, 2004

(54) Fuel injection system

(76) Inventors: Werner Berger, Markgroeningen (DE); Martin Mueller, Moeglingen (DE); Andreas Glaser, Stuttgtart (DE); Anh Tuan Hoang, Tamm (DE); Martin Buehner, Backnang (DE); Cedric Olivier, Ludwigsburg (DE)

Correspondence Address: KENYON & KENYON, ONE BROADWAY, NEW YORK, NY, 10004, US

(21) Appl. No.: 10/470,796

(22) PCT Filed: Sep. 23, 2002
(86) PCT No.: PCT/DE02/03600

(30) Foreign Application Priority Data
Nov. 30, 2001 (DE) 101 58 787.2

(51) Int. Cl. F02M 55/02

(52) U.S. Cl. 123/468

(57) ABSTRACT

A fuel-injection system for injecting fuel into an internal combustion engine, having at least one fuel injector (2) and a fuel-distributor line, is provided with an inflow (3) for each fuel injector (2), which has a flexible section (16) and is connectable to an inflow section (6) of the fuel injector (2). The flexible section (16) is made up of three concentric sleeve sections (9, 11, 13) which radially overlap at least partially and are interconnected by bends (14), doubled when viewed in the axial cross section.

### BACKGROUND INFORMATION

The present invention is based on a fuel-injection system for injecting fuel into an internal combustion engine according to the definition of the species in the main claim.

From laid-open document DE-OS 28 29 057, a fuel-injection system is known which supplies fuel to a mixture-compressing internal combustion engine having external ignition as a function of operating parameters. The fuel-injection system includes a metal fuel-distributor line which is connected via at least one branch line to at least one fuel injector, the branch line being embodied as a metal tube and connected to the fuel injector by way of a threaded connection. Easily bendable metal is used as material for the branch line. Situated between the threaded connection on the branch line and the fuel injector are thin-walled metal bellows in the form of expansion bellows which compensate a lateral offset between the beginning of the branch line on the fuel-distributor line and the fitting position of the fuel injector.

Disadvantageous in the fuel-injection system known from the laid-open document DE-OS 28 29 057 is that the expansion bellows require a minimum number of convolutions in order to compensate both for tolerances of the overall length and for tilting of the axes of the fuel injector and the beginning of the fuel-distributor line. The angle compensation (angular compensation) and the side compensation (lateral compensation) require the expansion bellows to have a minimum length.

From U.S. Pat. No. 2,014,355, a pipe connection in the form of a corrugated tube is known, which is meant to prevent, or reduce, the transmission of vibrations. On the outside, the corrugated tube is surrounded by an envelope which does not contact the corrugated tube and which is rigidly connected to the one pipe section at one end. At its other end, a flexible seal seals the envelope from the other pipe section, the envelope shielding from noise originating in the corrugated tube.

This known related art also has the already mentioned disadvantages.

### SUMMARY OF THE INVENTION

In contrast, the fuel-injection system according to the present invention, having the characterizing features of the main claim, has the advantage over the related art that the inflow and the flexible section have a low overall height but nevertheless allow an angle compensation and a lateral compensation over a large area. Specifically, the compensation is achieved by elastic deformation of the flexible section itself, and there is no danger of a seal leaking over time.

The measures specified in the dependent claims permit advantageous further developments and improvements of the fuel injection system indicated in the main claim.

Advantageously, a third sleeve section having the largest diameter is axially positioned between a first and a second sleeve section, the first sleeve section and second sleeve section having identical diameters.

Without narrowing the flow cross-section of the fuel inflow, an angle compensation and lateral compensation may be attained given low overall length.

The bends, double in the axial cross section, are advantageously embodied in s-form.

The deformation of the flexible section is evenly distributed over the region bent in an s-shape. A longitudinal compensation across a large area is made possible in an advantageous manner.

The sleeve sections and bends may be made from sheet metal.

### BRIEF DESCRIPTION OF THE DRAWINGS

An exemplary embodiment of the present invention is represented in the drawing in simplified form and elucidated in greater detail in the following description.

The figure shows:

FIG. 1 a section through an exemplary embodiment of a fuel-injection system configured according to the present invention, in the sectional plane of a fuel injector and an inflow of a fuel-distributor line.

### DESCRIPTION OF THE EXEMPLARY EMBODIMENT

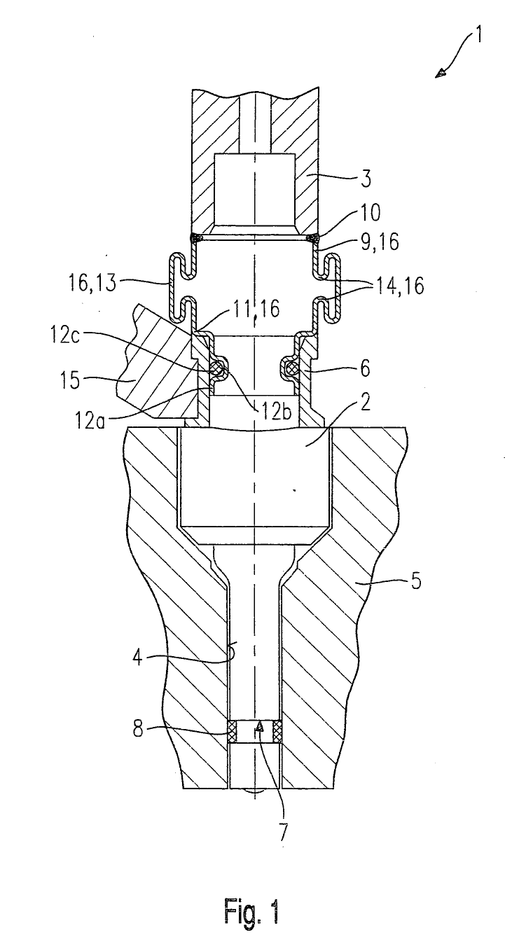

FIG. 1 shows an axial section through an exemplary embodiment of a fuel-injection system 1 according to the present invention, in the plane of a fuel injector 2 and an inflow 3 of a fuel-distributor line, which is not shown here. Fuel injector 2 is inserted in a bore 4 of a cylinder head 5 of an internal combustion engine and shown in a sectioned view in the area of an inflow region 6.

Fuel injector 2 is sealed from bore 4 by a sealing ring 8, made of elastomer, for instance, which is located in a groove 7.

A first sleeve section 9 is connected to inflow 3 via a welded seam 10. A second sleeve section 11 is connected to a guide section 12a which is inserted in inflow section 6 of fuel injector 2 and includes a groove 12b having a sealing ring 12c to seal from inflow section 6. Radially on the outside, first sleeve section 9 and second sleeve section 11 are enclosed by a third sleeve section 13. First, second and third sleeve sections 9, 11, 13 are joined via double bends 14, which have an S-shaped form in the axial cross section shown.

First sleeve section 9, second sleeve section 11, third sleeve section 13 and S-shaped bends 14 form a flexible section 16. Flexible section 16 is made from sheet metal such as spring steel.

Formed on inflow section 6 is a connecting plug 15 for the control of fuel injector 2.

Advantageously, a compensation may take place in case of a laterial deviation or tilting between inflow 3 and inflow section 6. Deviation in the clearance between inflow 3 and inflow section 6 may likewise be compensated for by deformation of flexible section 16, especially of S-shaped bends 14. Only a small overall height of flexible section 16 is required, although relatively large tolerances may be compensated for compared to the related art.

By a correspondingly rigid design of flexible section 16 it is possible for flexible section 16 to exert a holding-down force on fuel injector 2 from the fuel-distributor line, by which fuel injector 2 is held down in bore 4, counter to the combustion pressure, so that no special holding-down devices are required.

What is claimed is:

1. A fuel-injection system for injecting fuel into an internal combustion engine having at least one fuel injector (2) and a fuel-distributor line which, for each fuel injector (2), has an inflow (3) including a flexible section (16), the inflow being connectable to an inflow section (6) of the fuel injector (2),
wherein the flexible section (16) is made up of three concentric sleeve sections (9, 11, 13) which radially overlap at least partially and are interconnected by bends (14), doubled when viewed in the axial cross section.

2. The fuel-injection system as recited in claim 1,
wherein a third sleeve section (13) having the largest diameter is axially positioned between a first sleeve section (9) and a second sleeve section (11).

3. The fuel-injection system as recited in claim 2,
wherein a first sleeve section (9) and a second sleeve section (11) have identical diameters.

4. The fuel-injection system as recited in one of claims 1 through 3,
wherein the bends (14), double in the axial cross section, have an s-shape.

5. The fuel-injection system as recited in one of claims 1 through 4,
wherein the sleeve sections (9, 11, 13) and the bends (14) are made from sheet metal.

6. The fuel-injection system as recited in one of claims 1 through 5,
wherein the flexible section (16) is fixedly connected to the inflow (3) of the fuel-distributor line.

7. The fuel-injection system as recited in claim 6, wherein
the fixed connection between the inflow (3) and the flexible section (16) is obtained by welding.
